(19) United States
(12) Patent Application Publication
(10) Pub. No.: US 2025/0346226 A1
(43) Pub. Date: Nov. 13, 2025

(54) AUTONOMOUS DRIVING VEHICLE AND CONTROL METHOD THEREOF

(71) Applicants: Hyundai Motor Company, Seoul (KR); Kia Corporation, Seoul (KR)

(72) Inventor: Je Kyung Lee, Hwaseong-Si (KR)

(21) Appl. No.: 18/966,443

(22) Filed: Dec. 3, 2024

(30) Foreign Application Priority Data
May 10, 2024 (KR) 10-2024-0062077

(51) Int. Cl. B60W 30/14; B60W 10/06; B60W 10/10; B60W 60/00

(52) U.S. Cl. CPC B60W 30/14; B60W 10/06; B60W 10/10; B60W 60/001; B60W 2540/30; B60W 2552/15; B60W 2555/20

(57) ABSTRACT

A method performed by an apparatus for controlling driving of a vehicle is introduced. The method may comprise, during a smart cruise control (SCC) operation, comparing, by one or more processors of the apparatus, a road condition with a pre-set standard road condition, wherein the vehicle is driven based on control information of the vehicle on a road associated with the road condition. The method further includes determining, based on the road condition being different from the pre-set standard road condition, whether a driver's operation data is detected or not, changing, based on the determination, a control condition for controlling driving of the vehicle, and controlling, based on the changed control condition, driving of the vehicle.

### CROSS-REFERENCE TO RELATED APPLICATION

The present application claims the benefit of priority to Korean Patent Application No. 10-2024-0062077, filed in the Korean Intellectual Property Office on May 10, 2024, the entire contents of which are incorporated herein by reference for all purposes.

### TECHNICAL FIELD

The present disclosure relates to an autonomous driving vehicle and a control method thereof.

### BACKGROUND

The matters described in this Background section are only for the enhancement of understanding of the background of the disclosure, and should not be taken as acknowledgment that they correspond to prior art already known to those skilled in the art.

Various convenient systems such as anti-lock brake system (ABS), electronic stability control system (ESC), smart cruise control system (SCC), and advanced driver assistance system (ADAS) may be mounted in vehicles to ensure driver's safety.

These various convenient systems control a vehicle's behaviors in consideration of road conditions to exhibit optimal performance. Here, the road conditions may mean high friction roads such as dry asphalt road and dry cement road and low friction roads such as rainy road, snowy road, and dusty road.

A road determination method may comprise a method to determine whether it is a high friction road or a low friction road based on kinetic data such as wheel speed, engine torque, and vehicle speed, and a method to determine whether it is a high friction road or a low friction road based on various sensors such as road directional ultrasonic sensor or microphone.

A road determination method based on kinetic data may identify whether a road is high-friction or low-friction by analyzing a slip phenomenon occurring in the vehicle. However, such method may fail to determine whether the road is high-friction or low-friction if the vehicle is traveling on a road with a certain pattern where neither rapid acceleration nor rapid deceleration occurs.

Further, a road determination method based on a road directional ultrasonic sensor presents an issue, as it may require the installation of an additional sensor. Consequently, this may increase the cost of vehicle production

### SUMMARY

The effects that may be obtained in the present disclosure are not limited to the effects described above, and other effects that have not been described will be clearly understood by those having ordinary knowledge in the technical field to which the present disclosure belongs, from the description below.

According to the present disclosure, a method performed by an apparatus for controlling driving of a vehicle, the method may comprise, during a smart cruise control (SCC) operation, determining, by one or more processors of the apparatus, based on control information of the vehicle, a road condition of a road on which the vehicle is driven, determining, based on the road condition being different from a pre-set standard road condition, whether a driver's operation data is detected or not, changing, based on the determination, a control condition for controlling driving of the vehicle, and controlling, based on the changed control condition, driving of the vehicle.

The method, wherein the changing the control condition may comprise one of, setting a first control condition for the control condition based on the driver's operation data being detected, or setting a second control condition for the control condition based on the driver's operation data not being detected.

The method may further comprise, controlling a power train of the vehicle with the first control condition to control driving of the vehicle.

The method, wherein the controlling the power train may comprise, controlling acceleration of the vehicle with a second gear of the power train, or controlling the power train by disabling interactions between the SCC and idle stop & go (ISG).

The method, wherein the controlling the power train may comprise, controlling the power train such that a shifting pattern of the vehicle is raised to a downshift line.

The method, wherein the controlling the power train may further comprise, controlling the power train such that the shifting pattern is lowered in advance before the vehicle stops.

The method, wherein the controlling the driving of the vehicle may comprise, controlling driving of the vehicle with the second control condition based on the SCC and a pre-set standard range being satisfied, wherein the satisfaction of the pre-set standard range is determined based on sensor information from the vehicle and navigation information from a navigation server.

The method, wherein the controlling the driving of the vehicle may comprise, controlling the driving of the vehicle based on the SCC such that a required acceleration of the SCC and a slope of the required acceleration are lowered.

The method, wherein the sensor information may comprise information from an illumination sensor of the vehicle and information from an ambient temperature sensor of the vehicle.

According to the present disclosure, a non-transitory computer-readable recording medium storing instructions that, when executed by one or more processors, are configured to cause the one or more processors to, during a smart cruise control (SCC) operation, determine, based on control information of the vehicle, a road condition of a road on which a vehicle is driven, determine, based on the road condition being different from a pre-set standard road condition, whether a driver's operation data is detected or not, change, based on the determination, a control condition for controlling driving of the vehicle, and control, based on the changed control condition, driving of the vehicle.

The non-transitory computer-readable recording medium wherein the instructions, when executed by the one or more processors, are configured to cause the one or more processors to control the driving of the vehicle based on the SCC such that a required acceleration of the SCC and a slope of the required acceleration are lowered.

According to the present disclosure, an apparatus for controlling driving of a vehicle, the apparatus may comprise, one or more processors configured to execute instructions, a memory storing the instructions that, when executed by the one or more processors, are configured to cause the apparatus to, during a smart cruise control (SCC) operation, determine, based on control information of the vehicle, a road condition of a road on which the vehicle is driven, determine, based on the road condition being different from a pre-set standard road condition, whether a driver's operation data is detected or not, and change, based on the determination, a control condition for controlling driving of the vehicle, and control, based on the changed control condition, driving of the vehicle.

The apparatus, wherein the instructions, when executed by the one or more processors, are configured to cause the apparatus to, set a first control condition for the control condition based on the driver's operation data being detected, and set a second control condition for the control condition based on the driver's operation data not being detected.

The apparatus, wherein the instructions, when executed by the one or more processors, are configured to cause the apparatus to control a power train of the vehicle with the first control condition to control driving of the vehicle.

The apparatus, wherein the instructions, when executed by the one or more processors, are configured to cause the apparatus to control at least one of, acceleration of the vehicle with a second gear of the power train, or the power train by disabling interactions between the SCC and idle stop & go (ISG).

The apparatus, wherein the instructions, when executed by the one or more processors, are configured to cause the apparatus to control the power train such that a shifting pattern of the vehicle is raised to a downshift line.

The apparatus, wherein the instructions, when executed by the one or more processors, are configured to cause the apparatus to control the power train such that the shifting pattern is lowered in advance before the vehicle stops.

The apparatus, wherein the instructions, when executed by the one or more processors, are configured to cause the apparatus to control the driving of the vehicle with the second control condition based on the SCC and a pre-set standard range being satisfied, wherein the satisfaction of the pre-set standard range is determined based on sensor information from the vehicle and navigation information provided from a navigation server.

The apparatus, wherein the instructions, when executed by the one or more processors, are configured to cause the apparatus to control the driving of the vehicle such that a required acceleration of the SCC and a slope of the required acceleration of the SCC are lowered.

The apparatus, wherein the sensor information may comprise information from an illumination sensor of the vehicle and information from an ambient temperature sensor of the vehicle.

### BRIEF DESCRIPTION OF THE DRAWINGS

FIG. 1 shows an example of an autonomous driving vehicle according to an example of the present disclosure.

FIG. 2 shows an example of a control method of an autonomous driving vehicle according to an example of the present disclosure.

FIG. 3, FIG. 4, and FIG. 5 are exemplary views to describe that driving of an autonomous driving vehicle is controlled under a first control condition in FIG. 2.

FIG. 6 and FIG.7 are exemplary views to describe that driving of an autonomous driving vehicle is controlled under a second control condition in FIG. 2.

### DETAILED DESCRIPTION

Hereinafter, examples of the present disclosure are described in detail with reference to attached drawings so as to be easily carried out by those having ordinary knowledge in the technical field to which the present disclosure belongs to. However, the present disclosure may be obtained in various different forms and is not limited to examples described here. In addition, parts not related to the description are omitted in drawings to clearly describe the present disclosure, and like reference numerals are used for like portions throughout the specification.

Throughout the specification, when a portion “includes” an element, this means that the portion does not exclude other elements unless otherwise defined, and may further include other elements. In addition, those indicated by like reference numerals mean like elements.

In addition, “unit” and “control unit” included in names such as vehicle control unit (VCU) are only terms widely used in names of a controller that control a specific vehicle function, and do not mean a generic function unit. For example, each controller may include a communication device that communicates with other controllers or sensors to control its function, a memory that stores an operation system, logic commands, or input/output information, and one or more processors that carry out determination, calculation, decision, and the like required to control its function.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of changing a control condition based on changes in road conditions) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of changing a control condition based on changes in road conditions) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of changing a control condition based on changes in road conditions) described herein.

Minimum risk maneuver (MRM) operation(s) may also be controlled, for example, based on one or more features (e.g., features of changing a control condition based on changes in road conditions) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle if a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of changing a control condition based on changes in road conditions) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of changing a control condition based on changes in road conditions) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

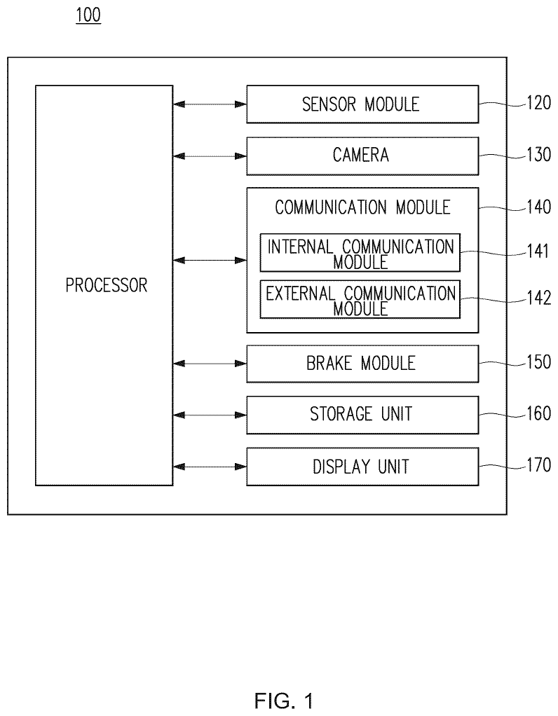

FIG. 1 shows an example of an autonomous driving vehicle according to an example of the present disclosure.

With reference to FIG. 1, an autonomous driving vehicle (100) according to an example of the present disclosure may include a processor (110), a sensor module (120), a camera (130), a communication module (140), a brake module (150), a storage unit (160), and a display unit (170).

The processor (110) is disposed in the autonomous driving vehicle (100), is electrically connected to at least one or more parts, modules, and the like mounted in the autonomous driving vehicle (100), and may take overall control of the autonomous driving vehicle (100) while exchanging various data or signals by using at least one or more electrically connected parts, module, and the like and wired/wireless communication.

For example, elements of the autonomous driving vehicle (100) may exchange signals or data via an internal communication module (141) which is the communication module (140) of the autonomous driving vehicle (100) under control of the processor (110). For example, the internal communication module (141) of the autonomous driving vehicle (100) may include at least one communication protocol (for example, CAN, LIN, FlexRay, MOST, Ethernet, and the like).

The processor (110) may carry out control of the autonomous driving vehicle (100) by control of other elements mounted in the autonomous driving vehicle (100). For example, the processor (110) may carry out at least one function of engine management system (EMS), electronic stability control (ESC), electronic stability program (ESP), vehicle dynamic control (VDC), lane keeping assistance system (LKAS), smart cruise control (SCC), adaptive cruise control (ACC), autonomous emergency braking (AEB), forward collision-avoidance assist (FCA), highway driving assist (HDA), highway driving pilot (HDP), lane departure warning (LDW), driver awareness warning (DAW), driver state warning (DSW), or traction control system (TCS). The functions described above may be referred to as advanced driver assist system (ADAS). SCC may be an advanced driver assistance system that automates speed and distance management while driving. Using sensors like radar and cameras, SCC adjusts the vehicle's speed to maintain a safe following distance from the car ahead and may even bring the vehicle to a complete stop in traffic and resume driving automatically. SCC may reduce driver fatigue, enhance safety by minimizing human error, and improve fuel efficiency by optimizing acceleration and braking. While highly effective on highways and in traffic, SCC may rely on clear road conditions and require driver oversight in complex scenarios.

The processor (110) may be provided with at least one or more sensor information from the sensor module (120) mounted in the autonomous driving vehicle (100), recognize a driving state or a driving condition of the autonomous driving vehicle (100) that drives based on the sensor information, and predict condition of a road where the autonomous driving vehicle (100) drives based thereon.

For example, the processor (110) may analyze the condition of the road where the autonomous driving vehicle (100) drives by using control information of the vehicle, when the smart cruise control (SCC) is activated. As a result of analysis of the processor (110), if the road condition is different from a pre-set standard road condition, it is possible to determine whether the driver's operation data is detected or not. The processor (110) may differently set a control condition under which driving of the autonomous driving vehicle (100) is controlled based on the determination result.

For example, the processor (110) can, as a result of determination, set a case where the driver's operation data is detected as a first control condition in the control condition, and a case where the driver's operation data is not detected as a second control condition that is different from the first control condition.

Here, the driver's operation data may include information that reflects the driver's intention. The driver may activate functions by clicking buttons (for example, terrain mode or snow switch) to take an active control of driving of the autonomous driving vehicle (100).

For example, the processor (110) may control a power train of the autonomous driving vehicle (100) when the first control condition is set, and control driving of the autonomous driving vehicle (100) based thereon. For example, the processor (110) may control the power train of the autonomous driving vehicle (100), and control two-stage acceleration of the autonomous driving vehicle (100) and control such that the smart cruise control and the idle stop & go (ISG) do not interwork with each other. ISG is a system designed to enhance fuel efficiency and reduce emissions by automatically shutting off the engine if the vehicle is stationary, such as at traffic lights or in traffic jams, and restarting it if the driver is ready to move. The system keeps auxiliary functions like air conditioning and lights operational during engine-off periods. By eliminating unnecessary idling, ISG saves fuel, reduces CO₂ emissions, and improves energy efficiency, particularly in urban driving conditions. It relies on an enhanced starter motor, a robust battery system, and sensors to manage frequent engine restarts. While beneficial, ISG may pose challenges in compatibility with other systems and may increase wear on starter components.

The processor (110) may control the power train of the autonomous driving vehicle (100), control such that a shifting pattern of the autonomous driving vehicle (100) is raised to a downshift line, and control such that the shifting pattern is lowered in advance before the autonomous driving vehicle (100) stops.

Unlike this, the processor (110) may be provided with at least one or more sensor information from the sensor module (120) mounted in the autonomous driving vehicle (100) and navigation information provided from a navigation server and analyze the information, and may control driving of the autonomous driving vehicle (100) based on the smart cruise control (SCC) activated if the pre-set standard range is satisfied as a result of analysis.

For example, the processor (110) may control driving of the autonomous driving vehicle (100) based on the smart cruise control (SCC), and control such that a required acceleration of the smart cruise control (SCC) and a slope of the required acceleration of the smart cruise control (SCC) are lowered.

The sensor module (120) is mounted in the autonomous driving vehicle (100), and may sense driving information, a driving condition, a surrounding environment, and the like of the autonomous driving vehicle (100) that drives on a road.

For example, the sensor module (120) may sense information on the surrounding of the autonomous driving vehicle (100) of an illumination sensor by using the illumination sensor and information on the external surrounding of the autonomous driving vehicle (100) of an ambient temperature sensor by using the ambient temperature sensor.

In addition or alternative, the sensor module (120) may accurately detect changes in the driving of the autonomous driving vehicle (100) by using at least one or more sensors, under control of the processor (110). Here, the at least one or more sensors may include a radar sensor, a light detection and ranging (LiDAR) sensor, an infrared sensor, an ultrasonic sensor, a laser sensor, and the like. For example, the laser sensor may accurately sense or recognize vehicle control information related to driving of the autonomous driving vehicle (100) and the like by using time-of-flight (TOF), phase-shift, or the like depending on a laser signal phase-shift method.

For example, the sensor module (120) can, under control of the processor (110), sense or recognize a target subject standing in front of the autonomous driving vehicle (100), an object driving in front of the autonomous driving vehicle (100), lanes on the road where the vehicle drives, surrounding environments of the road where the vehicle drives, and the like.

The at least one or more sensors described above may include a heading sensor, a yaw sensor, a gyro sensor, a vehicle forward traveling/backward traveling sensor, a wheel sensor, a vehicle speed sensor, a vehicle body slope detection sensor, a battery sensor, a fuel sensor, a tire sensor, a sensor for steering by handle turning, a vehicle internal temperature sensor, a vehicle internal humidity sensor, or a door sensor.

The camera (130) may collect images of the surroundings of the autonomous driving vehicle (100) or images of the inside of the autonomous driving vehicle (100). At least one or more cameras (130) are mounted in the autonomous driving vehicle (100) and may collect images of the area ahead, images of the area behind, and images of the area at the lateral side of the autonomous driving vehicle (100).

The camera (130) may provide the processor (110) with the collected images. For example, the processor (110) may process stopped images or videos by analyzing the collected images through the camera (130), and extract image information from the processed stopped images or videos.

For example, the camera (130) may include a charge coupled device (CCD) image sensor or a complementary metal oxide semiconductor (CMOS) image sensor. The camera (130) may include a three-dimensional space awareness sensor such as KINECT (RGB-D sensor), structured light sensor (TOF), and stereo camera (130).

The communication module (140) may communicate with at least one or more base stations, external devices, or other vehicles. Here, other vehicles may include a forward vehicle, a rear vehicle, and a side vehicle with respect to the autonomous driving vehicle (100) that drives.

The communication module (140) can, under control of the processor (110), receive driving information from other vehicles. The driving information may include position, speed, acceleration, direction, prediction path, path history, or forward collision-avoidance assist (FCA) signal of other vehicles.

For example, the communication module (140) may include an internal communication module (141) and an external communication module (142).

The internal communication module (141) may carry out transmission or reception by using various communication protocols existing inside the autonomous driving vehicle (100). Here, the communication protocol may include at least one of controller area network (CAN), CAN with flexible data rate (CAN FD), Ethernet, local interconnect network (LIN), and FlexRay. The communication protocol may include other protocols for communication between various devices loaded in the vehicle.

The external communication module (142) may carry out vehicle-to-vehicle (V2V) communication with other vehicle or carry out vehicle-to-infrastructure (V2I) communication with an infrastructure. Here, the infrastructure may be a roadside unit or a server that regularly transmits transportation information by interworking with transportation information system (TIS) or intelligent transport system (ITS).

The external communication module (142) is not limited thereto, and may carry out vehicle-to-everything (V2X) communication. The external communication module (142) may use various communication methods such as vehicular ad hoc network (VANET), wireless access in vehicular environments (WAVE), dedicated short range communication (DSRC), communication access in land mobile (CALM), vehicle-to-network (V2N), wireless LAN (WLAN) communication, wireless-fidelity (Wi-Fi) communication, wireless broadband (WiBro) communication, long term evolution (LTE) communication, long term evolution-advanced (LTE-A) communication, 5G communication, 6G communication, ultrawideband (UWB) communication, ZigBee communication, and near field communication (NFC) communication.

The communication module (140) may include at least one of a transmission antenna, a reception antenna, and a radio frequency (RF) circuit or an RF element that may implement various communication protocols.

In addition or alternative, the communication module (140) may carry out communication with a smart device of a driver or a passenger.

The brake module (150) can, under control of the processor (110), brake the autonomous driving vehicle (100) that drives. The brake module (150) may suddenly brake or gradually brake the autonomous driving vehicle (100) in response to a brake signal when a brake signal is provided, under control of the processor (110). Here, the brake signal may include a time-to-collision (TTC) signal (hereinafter, referred to as TTC signal) indicating time estimated or predicted for the autonomous driving vehicle (100) to collide with a forward vehicle or a rear vehicle.

The brake module (150) can, under control of the processor (110), slowly reduce a speed of the autonomous driving vehicle (100) or suddenly stop the vehicle based on the brake signal.

For example, the brake module (150) may include a plurality of wheel brakes (FL, FR, RL, and RR).

For example, the plurality of wheel brakes (FL, FR, RL, and RR) may include a first wheel brake (FL) that brakes a forward left wheel of the autonomous driving vehicle (100), a second wheel brake (FR) that brakes a forward right wheel of the autonomous driving vehicle (100), a third wheel brake (RL) that brakes a rear left wheel of the autonomous driving vehicle (100), and a fourth wheel brake (RR) that brakes a rear right wheel of the autonomous driving vehicle (100).

The plurality of wheel brakes may be installed corresponding to each wheel of the autonomous driving vehicle (100). For example, each of the plurality of wheel brakes (FL, FR, RL, and RR) may be independently braked, and may cause braking force in each wheel.

The storage unit (160) may be mounted in or separated from the autonomous driving vehicle (100). The storage unit (160) may store programs or information for controlling the advanced driver assist system (ADAS).

The storage unit (160) may store information sensed by the sensing module (120) (e.g., one or more sensors), image information collected by the camera (130), information generated by the processor (110), or information received by the communication module (140). The storage unit (160) is not limited thereto. Here, the storage unit (160) may be referred to as a memory.

The display unit (170) may be mounted inside the autonomous driving vehicle (100). The display unit (170) may display a driving assist system related to the autonomous driving vehicle (100), under control of the processor (110). For example, the display unit (170) may include a cluster.

As described above, the autonomous driving vehicle (100) according to an example of the present disclosure analyzes, under control of the processor (110), condition of a road where the autonomous driving vehicle (100) drives by using control information of the vehicle, when the smart cruise control (SCC) is activated, as a result of analysis, if the road condition is different from a pre-set standard road condition, determines whether a driver's operation data is detected or not, and based on this, controls driving of the autonomous driving vehicle by actively or passively differentiating thereof, thereby ensuring reliability and easiness of SCC control.

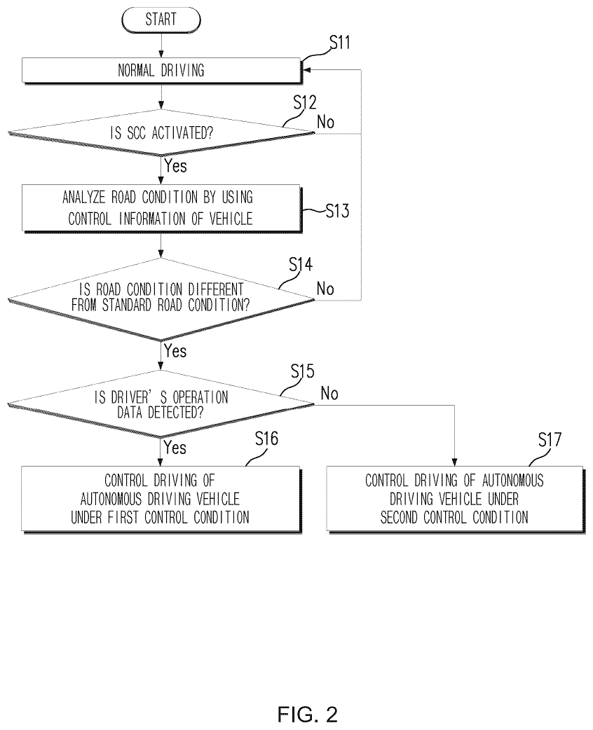

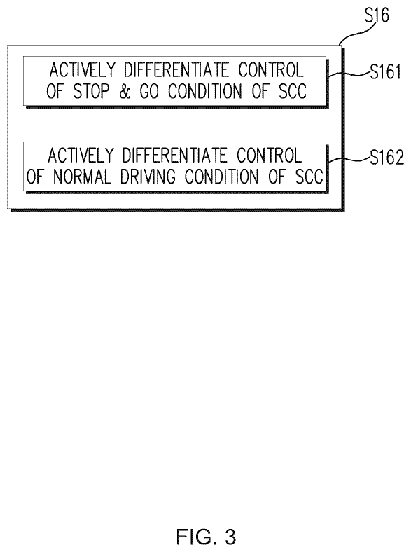

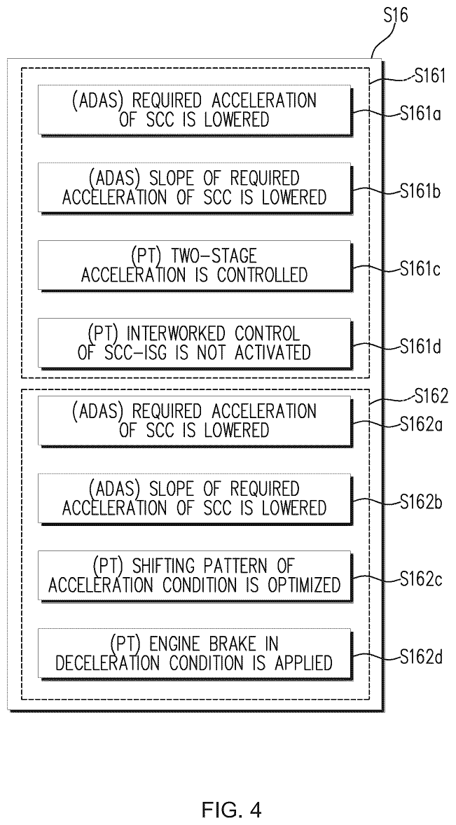

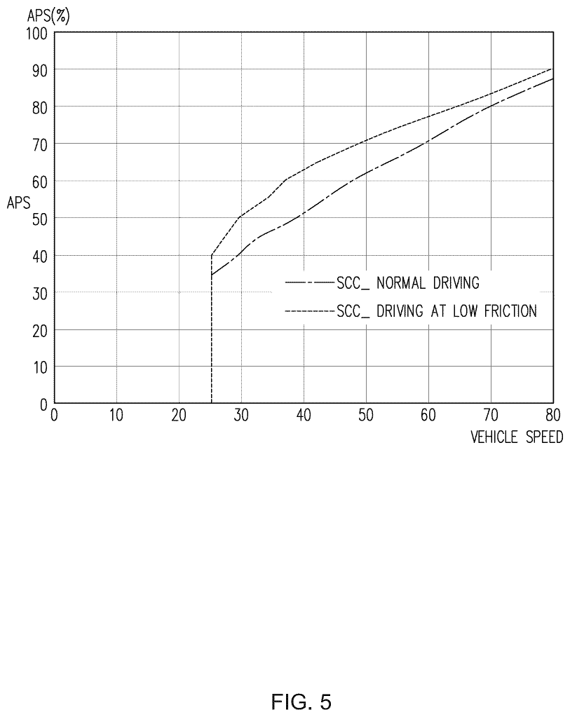

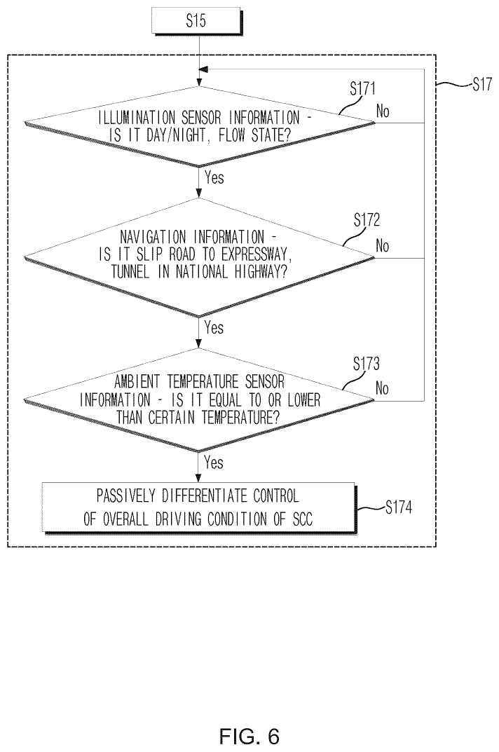

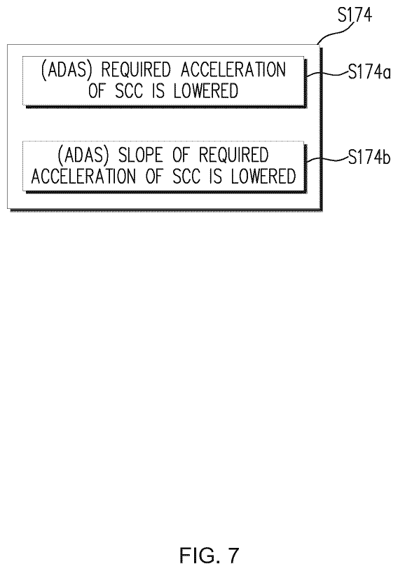

FIG. 2 shows an example of a control method of the autonomous driving vehicle according to an example of the present disclosure, FIGS. 3 to 5 are exemplary views to describe that driving of the autonomous driving vehicle is controlled under a first control condition in FIG. 2, and FIGS. 6 and 7 are exemplary views to describe that driving of the autonomous driving vehicle is controlled under a second control condition in FIG. 2.

For convenience, FIG. 2 is described by way of an example in which the steps are performed by a processor (e.g., control circuitry). One, some, or all steps of FIG. 2, or portions thereof, may be performed by one or more other circuits. One or some, steps of FIG. 2 may be omitted, performed in other orders, and/or otherwise modified, and/or one or more additional steps may be added.

With reference to FIG. 2, the control method of the autonomous driving vehicle (100) including the processor (110) according to an example of the present disclosure is as follows.

The autonomous driving vehicle (100) can, under control of the processor (110), generally drive on a road.

The autonomous driving vehicle (100) can, under control of the processor (110), analyze a road condition where the autonomous driving vehicle (100) drives by using control information of the vehicle (S13), when the smart cruise control (SCC) is activated (S12).

For example, the processor (110) may analyze a control state related to ESC, TCS, and ABS by using control information of the vehicle. For example, the processor (110) may analyze an intervention state regarding chassis control by comparatively analyzing real vehicle speed and reference vehicle speed.

Here, the real vehicle speed (Vreal) may be determined by being provided with information on wheel speed (Whl Spd) via a CAN signal, and obtaining an average value of the provided wheel speed. The reference vehicle speed (Vref) may be determined as a target vehicle speed based on longitudinal control.

The autonomous driving vehicle (100) can, under control of the processor (110), comparatively analyze the road condition and the pre-set standard road condition (S14), and, if the road condition is substantially the same as the standard road condition, may determine that the road is a high friction road, thereby continuously maintaining normal driving (S14, No).

Unlike this, the autonomous driving vehicle (100) may, under control of the processor (110), comparatively analyze the road condition and the pre-set standard road condition (S14), and, if the road condition is different from the standard road condition, may determine that the road is a low friction road (S14, Yes).

The autonomous driving vehicle (100) can, under control of the processor (110), determine whether a driver's operation data is detected or not, if the road condition is different from the standard road condition (S15). For example, the autonomous driving vehicle (100) can, under control of the processor (110), differently set the control condition of controlling driving of the autonomous driving vehicle (100) based on the determination result (S16, S17). Here, the driver's operation data may be data related to Terrain (Snow) mode.

For example, the processor (110) may determine that the Terrain (Snow) mode is activated, when the driver's operation data is detected. Unlike this, the processor (110) may determine that the Terrain (Snow) mode is not activated, if the driver's operation data is not detected.

The autonomous driving vehicle (100) can, under control of the processor (110), set a case where the driver's operation data is detected as a first control condition in the control condition, and may control driving of the autonomous driving vehicle (100) based thereon (S16).

As shown in FIGS. 3 to 5, the autonomous driving vehicle (100) can, under control of the processor (110), control a power train of the autonomous driving vehicle (100), if the first control condition is set, and may control driving of the autonomous driving vehicle (100) based thereon (S16).

For example, the autonomous driving vehicle (100) can, under control of the processor (110), control the power train of the autonomous driving vehicle (100), distinguish the condition into the stop & go condition of SCC and the normal driving condition of SCC, and actively control the autonomous driving vehicle (100) based thereon, thereby differentiating driving of the autonomous driving vehicle (100) (S161, S162).

For example, if the condition is the stop & go condition of SCC, the processor (110) may lower a required acceleration of SCC or lower a slope of the required acceleration of SCC by using advanced driver assist system (ADAS) (S161a, S161b).

If the condition is the stop & go condition of SCC, the processor (110) may control two-stage acceleration of the autonomous driving vehicle (100) by using the power train of the autonomous driving vehicle (100), control such that SCC and the idle stop & go (IGS) interwork with each other, or control such that interworked control of SCC and idle stop & go (ISG) is not activated.

For example, if the condition is a normal driving condition of SCC, the processor (110) may control such that the required acceleration of SCC is lowered or the slope of the required acceleration of SCC is lowered by using the advanced driver assist system (ADAS) (S162a, S162b).

If the condition is the normal driving condition of SCC, the processor (110) may optimize a shifting pattern of the acceleration condition by using the power train of the autonomous driving vehicle (100). For example, if the condition is the normal driving condition of SCC, the processor (110) may control such that a downshift line of the autonomous driving vehicle (100) is raised by using the power train of the autonomous driving vehicle (100) (S161c).

When showing this in a graph, it is as the graph shown in FIG. 5. In FIG. 5, the horizontal direction may indicate vehicle speed, and the vertical direction may indicate APS.

If the condition is the normal driving condition of SCC, the processor (110) may drive at a low friction of SCC by controlling such that the downshift line of the autonomous driving vehicle (100) is raised by using the power train of the autonomous driving vehicle (100). The autonomous driving vehicle (100) may prevent frequent downshift due to APS operation by driving at a low friction of SCC, under control of the processor (110).

In addition or alternative, if the condition is the normal driving condition of SCC, the processor (110) may apply an engine brake in a deceleration condition by using the power train of the autonomous driving vehicle (100). For example, if the condition is the normal driving condition of SCC, the processor (110) may add a map in which criteria of deceleration are added to the shifting pattern of SCC before controlling such that the shifting stage is lowered in advance and store thereof.

In addition or alternative, if the driver's operation data is not detected, the autonomous driving vehicle (100) can, under control of the processor (110), set the second control condition that is different from the first control condition, and may control driving of the autonomous driving vehicle (100) based thereon (S17).

If the second control condition is set, the autonomous driving vehicle (100) can, under control of the processor (110), be provided with at least one or more sensor information from a sensor module mounted in the autonomous driving vehicle (100) and navigation information provided from a navigation sever and analyze the information.

The autonomous driving vehicle (100) can, under control of the processor (110), control driving of the autonomous driving vehicle (100) based on the smart cruise control (SCC) activated if the pre-set standard range is satisfied as a result of analysis.

For example, as shown in FIGS. 6 and 7, the autonomous driving vehicle (100) can, under control of the processor (110), determine a day/night flow state by using illumination sensor information provided from an illumination sensor (S171). The autonomous driving vehicle (100) can, under control of the processor (110), determine that the pre-set standard range is satisfied, if the state is a night flow state.

The autonomous driving vehicle (100) can, under control of the processor (110), determine whether or not there is a slip road to an expressway or a tunnel in a national highway by using the navigation information provided from the navigation server (S172). The autonomous driving vehicle (100) can, under control of the processor (110), determine that the pre-set standard range is satisfied, if there is a slip road to a tunnel.

The autonomous driving vehicle (100) can, under control of the processor (110), determine whether or not a temperature is equal to or lower than a certain temperature by using information of an ambient temperature sensor provided from the ambient temperature sensor (S173). The autonomous driving vehicle (100) can, under control of the processor (110), determine that the pre-set standard range is satisfied, if the temperature is a below-zero temperature.

The autonomous driving vehicle (100) can, under control of the processor (110), predict that the road where the vehicle drives is a low friction road where there is black ice or the like, if the pre-set standard range is satisfied, as a result of analysis, and passively control the autonomous driving vehicle (100) based thereon, thereby differentiating driving of the autonomous driving vehicle (100) (S174).

For example, the processor (110) may control driving of the autonomous driving vehicle (100) based on the smart cruise control (SCC), if the pre-set standard range is satisfied, and may control such that the required acceleration of SCC is lowered or the slope of the required acceleration of SCC is lowered by using the advanced driver assist system (ADAS). (S174a, S174b).

As described above, the autonomous driving vehicle (100) according to an example of the present disclosure can, under control of the processor (110), analyze condition of the road where the autonomous driving vehicle (100) drives by using control information of the vehicle, when the smart cruise control (SCC) is activated, as a result of analysis, if the road condition is different from a pre-set standard road condition, determines whether a driver's operation data is detected or not, and based on this, controls driving of the autonomous driving vehicle by actively or passively differentiating driving of the autonomous driving vehicle, thereby ensuring reliability and easiness of SCC control.

The processor 150 may be a central processing unit (CPU) or a semiconductor device that processes instructions stored in a memory and/or a storage. The memory and the storage may include various types of volatile or non-volatile storage media. For example, the memory may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor. The software module may reside on a storage medium (that is, the memory and/or the storage) such as a RAM, a flash memory, a ROM, an EPROM, an EEPROM, a register, a hard disc, a removable disk, and a CD-ROM.

The exemplary storage medium may be coupled to the processor. The processor may read out information from the storage medium and may write information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

An object of the present disclosure is to provide an autonomous driving vehicle and a control method thereof, which may ensure reliability and easiness of SCC control by differentiating control of an autonomous driving vehicle depending on a road condition during SCC control.

The technical objects that the present disclosure is to achieve are not limited to the technical objects described above, and other technical objects that have not been described will be clearly understood by those having ordinary knowledge in the technical field to which the present disclosure belongs.

To achieve the technical objects as described above, there is provided a control method of a vehicle including a memory storing instructions and one or more processors configured to execute the instructions, the method comprising determining, by the one or more processors executing the instructions, based on control information of the vehicle, a road condition of a road on which the vehicle drives, in a smart cruise control (SCC), if the road condition is different from a pre-set standard road condition, determining, by the one or more processors executing the instructions, whether a driver's operation data is detected or not, setting, by the one or more processors executing the instructions, a control condition for controlling driving of the vehicle based on a result of the determination, and controlling, based on the changed control condition, driving of the vehicle.

In addition or alternative, differently setting the control condition may comprise setting a first control condition for the control condition if the driver's operation data is detected, and setting a second control condition for the control condition if the driver's operation data is not detected.

In addition or alternative, the control method may further include controlling a power train of the vehicle in response to the driver's operation data being detected.

In addition or alternative, the controlling the power train may comprise controlling acceleration of the vehicle with a second gear of the power train or controlling such that the SCC and idle stop & go (ISG) do not interwork with each other.

In addition or alternative, the controlling the power train may include controlling such that a shifting pattern of the vehicle is raised to a downshift line.

In addition or alternative, the controlling the power train may further comprise controlling such that the shifting pattern is lowered in advance before the vehicle stops.

In addition or alternative, the control method may further include controlling driving of the vehicle based on the SCC when a pre-set standard range is determined to be satisfied based on sensor information from a sensor module at the vehicle and navigation information provided from a navigation server.

In addition or alternative, controlling the driving of the vehicle based on the SCC may comprise controlling such that a required acceleration of the SCC and a slope of the required acceleration are lowered.

In addition or alternative, the sensor information may include information of an illumination sensor mounted at the vehicle and information of an ambient temperature sensor mounted at the vehicle.

In addition or alternative, the present disclosure includes a computer-readable recording medium on which a program to execute a control method described above.

In addition or alternative, to achieve the technical objects as described above, there is provided a vehicle according to an example of the present disclosure includes a memory storing instructions, one or more processors configured to execute the instructions, wherein the instructions cause, when executed by the one or more processors, the processor to determine, based on control information of the vehicle, a road condition of a road where the vehicle drives, in a smart cruise control (SCC), if the road condition is different from a pre-set standard road condition, determine whether a driver's operation data is detected or not, set a control condition for controlling driving of the vehicle based on a result of the determination, and control, based on the changed control condition, driving of the vehicle.

In addition or alternative, differently setting the control condition may comprise setting a first control condition for the control condition if the driver's operation data is detected, and setting a second control condition for the control condition if the driver's operation data is not detected.

In addition or alternative, the instructions may further cause the processor to control a power train of the vehicle in response to the driver's operation data being detected.

In addition or alternative, controlling the power train may comprise controlling acceleration of the vehicle with a second gear of the power train or controlling such that the SCC and idle stop & go (ISG) do not interwork with each other.

In addition or alternative, controlling the power train may comprise controlling such that a shifting pattern of the vehicle is raised to a downshift line.

In addition or alternative, controlling the power train may further comprise controlling such that the shifting pattern is lowered in advance before the vehicle stops.

In addition or alternative, the instructions may further cause the processor to control driving of the vehicle based on the SCC if a pre-set standard range is determined to be satisfied based on sensor information from a sensor module at the vehicle and navigation information provided from a navigation server.

In addition or alternative, controlling the driving of the vehicle based on the SCC may comprise controlling such that a required acceleration of the SCC and a slope of the required acceleration of the SCC are lowered.

In addition or alternative, the sensor information may include information of an illumination sensor mounted at the vehicle and information of an ambient temperature sensor mounted at the vehicle.

The vehicle and the control method thereof of the present disclosure configured as described above have the following effects.

It is possible to ensure reliability and easiness of the SCC control by differentiating control of the vehicle depending on a road condition during SCC control.

It is possible to differentiate a condition which is concerned of being low friction that is not easy for a driver to recognize during the SCC control by passive control.

It is possible to differentiate the condition by active control if a driver directly activates a terrain mode or a snow switch in a circumstance where the driving condition is satisfied.

It is possible to provide reliable performance before intervention of other control due to vehicle behavior instability in a use condition with respect to convenient function of autonomous driving through control differentiation.

The present disclosure described above may be implemented as a computer-readable code on a medium on which a program is recorded. The computer-readable medium includes all kinds of recording devices in which data that may be read by a computer system is stored. Examples of the computer-readable media include hard disk drive (HDD), solid state disk (SSD), silicon disk drive (SDD), ROM, RAM, CD-ROM, magnetic tape, floppy disk, optical data storage device, and the like.

Therefore, the above detailed description should not be construed as being limited, and should be considered as being exemplary. The scope of the present disclosure should be determined by reasonable interpretation of the attached claims, and all modifications within the equivalent scope of the present disclosure are included in the scope of the present disclosure.

What is claimed is:

1. A method performed by an apparatus for controlling driving of a vehicle, the method comprising:
during a smart cruise control (SCC) operation, determining, by one or more processors of the apparatus, based on control information of the vehicle, a road condition of a road on which the vehicle is driven;
determining, based on the road condition being different from a pre-set standard road condition, whether a driver's operation data is detected or not;
changing, based on the determination, a control condition for controlling driving of the vehicle; and
controlling, based on the changed control condition, driving of the vehicle.

2. The method according to claim 1, wherein the changing the control condition comprises one of:
setting a first control condition for the control condition based on the driver's operation data being detected; or
setting a second control condition for the control condition based on the driver's operation data not being detected.

3. The method according to claim 1, further comprising:
controlling a power train of the vehicle in response to the driver's operation data being detected.

4. The method according to claim 3, wherein the controlling the power train comprises:
controlling acceleration of the vehicle with a second gear of the power train; or
controlling the power train by disabling interactions between the SCC and idle stop & go (ISG).

5. The method according to claim 3, wherein the controlling the power train comprises:
controlling the power train such that a shifting pattern of the vehicle is raised to a downshift line.

6. The method according to claim 5, wherein the controlling the power train further comprises:
controlling the power train such that the shifting pattern is lowered in advance before the vehicle stops.

7. The method according to claim 1, wherein the controlling the driving of the vehicle comprises:
controlling driving of the vehicle based on the SCC and a pre-set standard range being satisfied, wherein the satisfaction of the pre-set standard range is determined based on sensor information from the vehicle and navigation information from a navigation server.

8. The method according to claim 1, wherein the controlling the driving of the vehicle comprises:
controlling the driving of the vehicle based on the SCC such that a required acceleration of the SCC and a slope of the required acceleration are lowered.

9. The method according to claim 7, wherein the sensor information comprises information from an illumination sensor of the vehicle and information from an ambient temperature sensor of the vehicle.

10. A non-transitory computer-readable recording medium storing instructions that, when executed by one or more processors, are configured to cause the one or more processors to:
during a smart cruise control (SCC) operation, determine, based on control information of a vehicle, a road condition of a road on which the vehicle is driven;
determine, based on the road condition being different from a pre-set standard road condition, whether a driver's operation data is detected or not;
change, based on the determination, a control condition for controlling driving of the vehicle; and
control, based on the changed control condition, driving of the vehicle.

11. The non-transitory computer-readable recording medium according to claim 10, wherein the instructions, when executed by the one or more processors, are configured to cause the one or more processors to control the driving of the vehicle based on the SCC such that a required acceleration of the SCC and a slope of the required acceleration are lowered.

12. An apparatus for controlling driving of a vehicle, the apparatus comprising:
one or more processors configured to execute instructions;
a memory storing the instructions that, when executed by the one or more processors, are configured to cause the apparatus to:
during a smart cruise control (SCC) operation, determine, based on a control information of the vehicle, a road condition of a road on which the vehicle is driven;
determine, based on the road condition being different from a pre-set standard road condition, whether a driver's operation data is detected or not; and
change, based on the determination, a control condition for controlling driving of the vehicle; and
control, based on the changed control condition, driving of the vehicle.

13. The apparatus according to claim 12, wherein the instructions, when executed by the one or more processors, are configured to cause the apparatus to:
set a first control condition for the control condition based on the driver's operation data being detected; and
set a second control condition for the control condition based on the driver's operation data not being detected.

14. The apparatus according to claim 12, wherein the instructions, when executed by the one or more processors, are configured to cause the apparatus to control a power train of the vehicle in response to the driver's operation data being detected.

15. The apparatus according to claim 14, wherein the instructions, when executed by the one or more processors, are configured to cause the apparatus to control at least one of:
acceleration of the vehicle with a second gear of the power train; or
the power train by disabling interactions between the SCC and idle stop & go (ISG).

16. The apparatus according to claim 14, wherein the instructions, when executed by the one or more processors, are configured to cause the apparatus to control the power train such that a shifting pattern of the vehicle is raised to a downshift line.

17. The apparatus according to claim 16, wherein the instructions, when executed by the one or more processors, are configured to cause the apparatus to control the power train such that the shifting pattern is lowered in advance before the vehicle stops.

18. The apparatus according to claim 12, wherein the instructions, when executed by the one or more processors, are configured to cause the apparatus to control the driving of the vehicle based on the SCC and a pre-set standard range being satisfied, wherein the satisfaction of the pre-set standard range is determined based on sensor information from the vehicle and navigation information provided from a navigation server.

19. The apparatus according to claim 12, wherein the instructions, when executed by the one or more processors, are configured to cause the apparatus to control the driving of the vehicle such that a required acceleration of the SCC and a slope of the required acceleration of the SCC are lowered.

20. The apparatus according to claim 18, wherein the sensor information comprises information from an illumination sensor of the vehicle and information from an ambient temperature sensor of the vehicle.
